(19) United States
(12) Patent Application Publication
(10) Pub. No.: US 2026/0279629 A1
(43) Pub. Date: Sep. 17, 2026

(54) GRAIN-ORIENTED ELECTRICAL STEEL SHEET AND METHOD FOR FORMING INSULATING COATING

(71) Applicant: NIPPON STEEL CORPORATION, Tokyo (JP)

(72) Inventors: Kazutoshi TAKEDA, Tokyo (JP); Shinsuke TAKATANI, Tokyo (JP); Takashi KATAOKA, Tokyo (JP); Yuuki KOGAKURA, Tokyo (JP)

(73) Assignee: NIPPON STEEL CORPORATION, Tokyo (JP)

(21) Appl. No.: 19/473,459

(22) PCT Filed: Apr. 12, 2024
(86) PCT No.: PCT/JP2024/014841

§ 371 Date: Oct. 7, 2025

(30) Foreign Application Priority Data
Apr. 12, 2023 (JP) 2023-064826

(51) Int. Cl. H01F 1/147; C23C 22/12; C23C 22/20; C23C 22/22; C23C 22/78; C23C 22/82; H01F 27/245; H01F 41/02

(52) U.S. Cl. CPC H01F 1/14783; C23C 22/12; C23C 22/20; C23C 22/22; C23C 22/78; C23C 22/82; H01F 27/245; H01F 41/0233

(57) ABSTRACT

The grain-oriented electrical steel sheet includes: a base steel sheet; and an insulating coating formed on a surface of the base steel sheet, in which the insulating coating includes: an intermediate layer that is formed on a side of the base steel sheet and contains a crystalline metal phosphate; and a tension coating layer formed on a surface side of the insulating coating, and when an interface between the base steel sheet and the intermediate layer is observed with a scanning electron microscope at a magnification of 5000 in a cross section along a thickness direction of the intermediate layer, the ratio of an interface length L to a width W of analyzing image is 100.0 to 120.0%.

### TECHNICAL FIELD

The present invention relates to a grain-oriented electrical steel sheet and a method for forming an insulating coating.

Priority is claimed on Japanese Patent Application No. 2023-064826, filed Apr. 12, 2023, the content of which is incorporated herein by reference.

### BACKGROUND ART

A grain-oriented electrical steel sheet is mainly used for a transformer. The transformer is continuously magnetized for a long period of time from installation to disposal and continues to generate energy loss. Therefore, energy loss when the transformer is magnetized by alternating current, that is, iron loss, is a main index for determining performance of the transformer.

In order to reduce the iron loss of the grain-oriented electrical steel sheet, many techniques have been developed so far from the viewpoint of (a) increasing development in the {110}<001> orientation (Goss orientation), (b) increasing the amount of a solid solution element such as Si to increase the electric resistance of the steel sheet, or (c) reducing the sheet thickness of the electrical steel sheet.

In addition, applying tension to the steel sheet is effective for reducing iron loss. It is an effective means for reducing iron loss to form a coating made of a material having a thermal expansion coefficient smaller than that of the steel sheet on a sheet surface at a high temperature. A forsterite-based coating (inorganic coating) having excellent coating adhesion, generated by a reaction between an oxide on a sheet surface and an annealing separator in a finishing annealing step of an electrical steel sheet, is a coating capable of applying tension to the steel sheet.

For example, a method for forming an insulating coating by baking a coating liquid mainly containing colloidal silica and a phosphate on a sheet surface, disclosed in Patent Document 1, is an effective method for reducing iron loss because the method has a large effect of applying tension to the steel sheet. Therefore, a general method for manufacturing a grain-oriented electrical steel sheet is to leave the forsterite-based coating generated in the finishing annealing step and to form an insulating coating mainly containing a phosphate on the forsterite-based coating.

However, in recent years, there has been an increasing demand for miniaturization and high performance of a transformer, and in order to miniaturize the transformer, a grain-oriented electrical steel sheet is required to have excellent high magnetic field iron loss such that iron loss is favorable even when magnetic flux density is high. At the same time, in recent years, it has been clarified that the forsterite-based coating hinders movement of a domain wall and adversely affects iron loss. In a grain-oriented electrical steel sheet, a magnetic domain changes by movement of a domain wall under an alternating magnetic field. Smooth and rapid movement of the domain wall is effective for reducing iron loss, but the forsterite-based coating itself is a non-magnetic body and has an uneven structure at a steel sheet/coating interface, and this uneven structure hinders movement of the domain wall. Therefore, it is considered that the forsterite-based coating adversely affects iron loss.

Therefore, as a means for improving the high magnetic field iron loss, a method of removing the inorganic coating using mechanical means such as polishing or chemical means such as pickling has been studied. In addition, a technique for manufacturing a grain-oriented electrical steel sheet having no inorganic coating by preventing generation of an inorganic coating in high-temperature finishing annealing, and a technique for bringing a sheet surface into a mirror surface state (in other words, a technique for magnetically smoothing a sheet surface) have been studied.

As a technique for preventing generation of an inorganic coating, for example, Patent Document 2 discloses a technique in which a surface-formed product is removed by pickling after normal finishing annealing, and then a sheet surface is brought into a mirror surface state by chemical polishing or electrolytic polishing. It has been found that a better iron loss improving effect can be obtained by forming a tension-applying insulating coating on the surface of a grain-oriented electrical steel sheet without an inorganic coating, obtained by such a known method. In addition, the tension-applying insulating coating can impart various characteristics such as corrosion resistance, heat resistance, and slippage, in addition to improvement of iron loss.

However, the inorganic coating has an effect of exhibiting insulation properties and an effect as an intermediate layer for ensuring adhesion when a tension coating (tension-applying insulating coating) is formed. That is, since the inorganic coating is formed in a state of deeply entering the steel sheet, the inorganic coating is excellent in adhesion to the steel sheet, which is metal. Therefore, when a tension-applying type coating (tension coating) containing colloidal silica, a phosphate, or the like as a main component is formed on the surface of the inorganic coating, coating adhesion is excellent.

On the other hand, since it is generally difficult to bond metal and oxide to each other, it is difficult to ensure sufficient adhesion between the tension coating and the surface of a steel sheet when the inorganic coating is not present.

Therefore, in a case where a tension coating is formed on a grain-oriented electrical steel sheet having no inorganic coating, it has been studied to form a layer that plays a role as an intermediate layer of the inorganic coating.

For example, Patent Document 3 discloses a technique in which a grain-oriented electrical steel sheet having no inorganic coating is annealed in a weakly reducing atmosphere, and silicon inevitably contained in a silicon steel sheet is thermally oxidized selectively to form a SiO₂ layer on the sheet surface, and then a tension-applying type insulating coating is formed. Patent Document 4 discloses a technique in which a grain-oriented electrical steel sheet having no inorganic coating is subjected to an anodic electrolytic treatment in a silicate aqueous solution to form a SiO₂ layer on a sheet surface, and then a tension-applying type insulating coating is formed.

However, in the technique disclosed in Patent Document 3, it is necessary to prepare an annealing facility capable of controlling an atmosphere in order to perform annealing in a weakly reducing atmosphere, and there is a problem in treatment cost. In the technique disclosed in Patent Document 4, it is necessary to prepare a new electrolysis treatment facility in order to obtain a SiO₂ layer that maintains sufficient adhesion to a tension-applying type insulating coating on a sheet surface by performing an anodic electrolytic treatment in a silicate aqueous solution, and there is a problem in treatment cost.

On the other hand, Patent Document 5 discloses a grain-oriented electrical steel sheet including: a base steel sheet; and an insulating coating formed on the surface of the base steel sheet, in which the insulating coating includes: an intermediate layer that is formed on the side of the base steel sheet and contains a crystalline metal phosphate; and a tension coating layer formed on the surface side of the insulating coating. In the grain-oriented electrical steel sheet, the intermediate layer can be formed by chemical conversion treatment.

Further, Patent Document 6 discloses a manufacturing method of a unidirectional silicon steel sheet in which a secondary-recrystallized unidirectional silicon steel sheet is formed with a coating mainly containing zinc phosphate in an amount of 0.1 g/m² or more and 10 g/m² or less per one surface of the steel sheet before a tension-imparting insulating coating is formed.

### CITATION LIST

### Patent Documents

Patent Document 1: Japanese Unexamined Patent Application, First Publication No. S48-039338
Patent Document 2: Japanese Unexamined Patent Application, First Publication No. S49-96920
Patent Document 3: Japanese Unexamined Patent Application, First Publication No. H06-184762
Patent Document 4: Japanese Unexamined Patent Application, First Publication No. H11-209891
Patent Document 5: PCT International Publication No. WO 2022/215710
Patent Document 6: Japanese Unexamined Patent Application, First Publication No. 2005-139481

### SUMMARY OF INVENTION

### Technical Problem

However, the present inventors studied conventional techniques as described in Patent Documents 5 and 6, and found that, when a grain-oriented electrical steel sheet obtained by a conventional technique is provided with a coating mainly containing a metal phosphate (intermediate layer) to improve the adhesion, the magnetic characteristics may deteriorate. On this point, the present inventors further studied, and found that the magnetic characteristics deteriorate because, when the intermediate layer is formed, that is, when chemical conversion treatment is performed, the crystal of metal phosphate is precipitated, and at the same time, the surface of the base metal is etched to form an uneven structure at the interface between the base metal and the intermediate layer, so that magnetic flux flow is suppressed in the base metal.

Therefore, an object of the present invention is to provide a grain-oriented electrical steel sheet that is excellent in adhesion with a tension coating and magnetic characteristics, and does not reduce the space factor of a transformer (core), and a method for forming an insulating coating therefor.

### Solution to Problem

The present inventors have found that: when a layer containing a metal phosphate is provided as an intermediate layer enhancing adhesion between the base steel sheet and the tension coating layer, the chemical treatment solution is adjusted to have ratios of metal ion, phosphate ion, and nitrate ion in a specific range, and thereby the interface between the intermediate layer and the base metal can be smoothed, so that a grain-oriented electrical steel sheet that is excellent in adhesion with a tension coating and magnetic characteristics, and does not reduce the space factor of a transformer (core) can be obtained.

The present invention has been made in view of the above findings. The gist of an embodiment according to the present invention is as follows.
[1] In an embodiment of the present invention, a grain-oriented electrical steel sheet includes: a base steel sheet; and an insulating coating formed on a surface of the base steel sheet, in which
the insulating coating includes:
   an intermediate layer that is formed on a side of the base steel sheet and contains a crystalline metal phosphate; and
   a tension coating layer formed on a surface side of the insulating coating, and
   when an interface between the base steel sheet and the intermediate layer is observed with a scanning electron microscope at a magnification of 5000 in a cross section along a thickness direction of the intermediate layer, the ratio of an interface length L to an width W of analyzing image is 100.0 to 120.0%.
[2] In the grain-oriented electrical steel sheet according to [1], the tension coating layer may contain a metal phosphate and silica.
[3] In an embodiment of the present invention, a method for forming an insulating coating, which is a method for forming the insulating coating included in the grain-oriented electrical steel sheet according to [1], includes:
a finishing annealing step of applying an annealing separator containing Al₂O₃ in an amount of 10 to 100 mass % onto a steel sheet, drying the steel sheet, and then finishing annealing the steel sheet;
an annealing separator removing step of removing an excess of the annealing separator from the steel sheet after the finishing annealing step;
a pickling step of pickling the steel sheet after the annealing separator removing step with 0.1 to 5 mass % of one inorganic acid selected from the group consisting of sulfuric acid, chloric acid, nitric acid, and phosphoric acid for 1 to 20 seconds;
an immersing step of immersing the steel sheet after the pickling step in a treatment liquid containing a metal phosphate, an oxidizing agent, and an iron ion;
a drying step of pulling up the steel sheet after the immersing step from the treatment liquid, removing an excess of the treatment liquid, and then drying the steel sheet; and
a tension coating layer forming step of applying a coating liquid containing a metal phosphate and colloidal silica, the metal phosphate and the colloidal silica contained in a total concentration of 10 to 40 mass % in terms of solid content, to the steel sheet after the drying step, drying the steel sheet, and then holding the steel sheet at a sheet temperature of 700 to 950° C. for 10 to 120 seconds, and
the treatment liquid has:
   a metal ion concentration of 1.0 to 10.0 g/L;
   a phosphate ion concentration of 2.0 to 25.0 g/L;
   a nitrate ion concentration of 2.0 to 40.0 g/L; and
   an iron ion concentration of 1.0 to 20.0 g/L, in which
   the phosphate ion concentration is in a ratio of 1.5 to 5.0 with respect to the metal ion concentration, and
   the nitrate ion concentration is in a ratio of 0.5 to 10.0 with respect to the phosphate ion concentration.
[4] In the method for forming an insulating coating according to [3], in the immersing step, the steel sheet after the pickling step may be immersed in the treatment liquid having a liquid temperature of 20 to 85° C. for 2 to 60 seconds.
[5] In the method for forming an insulating coating according to [3], the nitrate ion concentration may be 2.0 to 25.0 g/L.

### Advantageous Effects of Invention

According to an embodiment of the present invention, it is possible to provide a grain-oriented electrical steel sheet that is excellent in adhesion with a tension coating and magnetic characteristics, and does not reduce the space factor of a transformer (core), and a method for forming an insulating coating therefor.

### BRIEF DESCRIPTION OF DRAWINGS

FIG. 1 An example of a cross-sectional view of a grain-oriented electrical steel sheet according to the embodiment.

FIG. 2 A schematic view for illustrating how to determine unevenness index according to the embodiment.

### DESCRIPTION OF EMBODIMENTS

The grain-oriented electrical steel sheet according to an embodiment of the present invention (grain-oriented electrical steel sheet according to the embodiment) and a manufacturing method of a grain-oriented electrical steel sheet according to the embodiment, the method including a method for forming an insulating coating included in the grain-oriented electrical steel sheet according to the embodiment, will be described.

First, the grain-oriented electrical steel sheet according to the embodiment will be described.

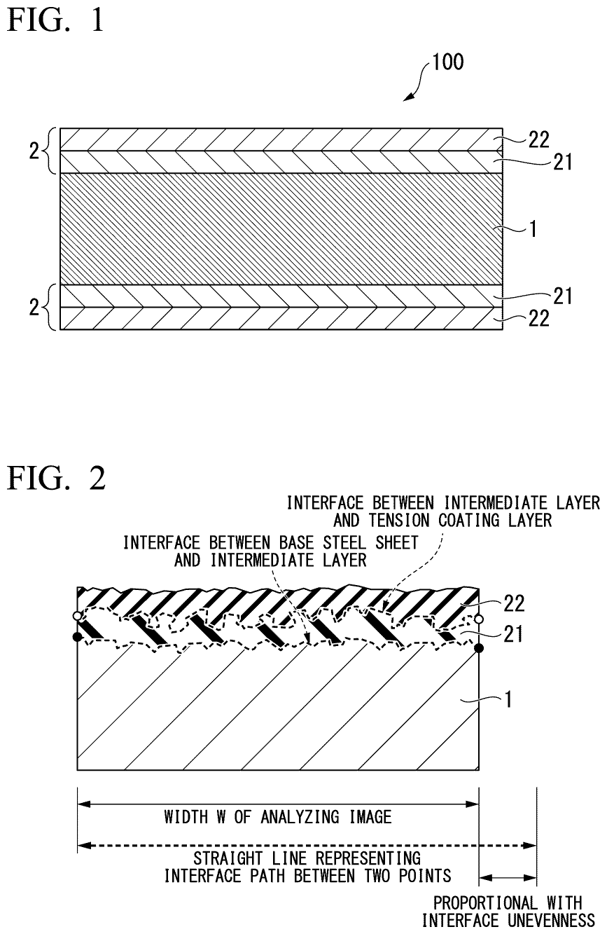

As illustrated in FIG. 1, a grain-oriented electrical steel sheet 100 according to the embodiment has a base steel sheet 1 and an insulating coating 2 formed on the surface of the base steel sheet 1.

The grain-oriented electrical steel sheet 100 according to the embodiment has substantially no forsterite-based coating on the surface of the base steel sheet 1. That is, in the embodiment, a forsterite-based coating is not intentionally formed on the surface of the base steel sheet 1. However, when the coating amount of the forsterite-based coating is 1 g/m² or less, the presence thereof is allowed (in this case, in a part between the base steel sheet 1 and the insulating coating 2). That is, the grain-oriented electrical steel sheet 100 according to the embodiment may have a forsterite-based coating in an amount of 0 to 1 g/m² on the surface of the base steel sheet 1.

The insulating coating 2 includes: a tension coating layer 22 formed on the surface side of the insulating coating 2 (that is, the surface side of the grain-oriented electrical steel sheet 100); and an intermediate layer 21 that is formed on the side of the base steel sheet 1 and contains a crystalline metal phosphate.

As for the intermediate layer 21, when the interface between the base steel sheet and the intermediate layer is observed with a scanning electron microscope at a magnification of 5000 in a cross section along the thickness direction of the intermediate layer, the ratio of the interface length L to the width W of analyzing image (unevenness index) is 100 to 120%.

Hereinafter, the configurations of the grain-oriented electrical steel sheet 100 each will be described.

### <Base Steel Sheet>

### (Chemical Composition)

The grain-oriented electrical steel sheet 100 according to the embodiment has a significant feature in the structure of the insulating coating 2 formed on the surface of the base steel sheet 1. The chemical composition of the base steel sheet 1 included in the grain-oriented electrical steel sheet 100 is not limited. However, in order to obtain characteristics generally required for a grain-oriented electrical steel sheet, the base steel sheet 1 preferably contains the following components as a chemical composition. In the embodiment, % relating to the chemical composition is mass % unless otherwise specified.

C: 0.010% or less

C (carbon) is an element effective in controlling the microstructure of the steel sheet in steps before the completion of the decarburization annealing step in the manufacturing process. However, when the C content exceeds 0.010%, the magnetic characteristics of the grain-oriented electrical steel sheet, which is a product sheet, are deteriorated. Therefore, in the base steel sheet of the grain-oriented electrical steel sheet according to the embodiment, the C content is preferably 0.010% or less. The C content is more preferably 0.005% or less. The C content is preferably as low as possible, but even when the C content is reduced to less than 0.0001%, the microstructure control effect is saturated, and manufacturing cost is merely increased. Therefore, the C content may be 0.0001% or more.

### Si: 2.50 to 4.00%

Si (silicon) is an element that increases the electric resistance of the grain-oriented electrical steel sheet and improves iron loss characteristics. When the Si content is less than 2.50%, a sufficient eddy-current loss reducing effect cannot be obtained. Therefore, the Si content is preferably 2.50% or more. The Si content is more preferably 2.70% or more, and still more preferably 3.00% or more.

On the other hand, when the Si content exceeds 4.00%, the grain-oriented electrical steel sheet is embrittled, and passability is significantly deteriorated. In addition, workability of the grain-oriented electrical steel sheet is deteriorated, and the steel sheet may be fractured during rolling. Therefore, the Si content is preferably 4.00% or less. The Si content is more preferably 3.80% or less, and still more preferably 3.70% or less.

### Mn: 0.01 to 0.50%

Mn (manganese) is an element that is bonded to S in the manufacturing process to form MnS. This precipitate functions as an inhibitor (inhibitor of normal grain growth) and causes secondary recrystallization in steel. Mn is also an element that enhances hot workability of steel. When the Mn content is less than 0.01%, the above effect cannot be sufficiently obtained. Therefore, the Mn content is preferably 0.01% or more. The Mn content is more preferably 0.02% or more.

On the other hand, when the Mn content exceeds 0.50%, secondary recrystallization does not occur, and the magnetic characteristics of steel are deteriorated. Therefore, in the base steel sheet of the grain-oriented electrical steel sheet according to the embodiment, the Mn content is preferably 0.50% or less. The Mn content is more preferably 0.20% or less, and still more preferably 0.10% or less.

N: 0.010% or less

N (nitrogen) is an element that is bonded to Al in the manufacturing process to form AlN that functions as an inhibitor. However, when the N content is more than 0.010%, the inhibitor excessively remains in the grain-oriented electrical steel sheet, and the magnetic characteristics are deteriorated. Therefore, in the base steel sheet of the grain-oriented electrical steel sheet according to the embodiment, the N content is preferably 0.010% or less. The N content is more preferably 0.008% or less.

On the other hand, the lower limit of the N content is not particularly limited, but even when the N content is reduced to less than 0.001%, manufacturing cost is merely increased. Therefore, the N content may be 0.001% or more.

Sol. Al: 0.020% or less

Sol. Al (acid-soluble aluminum) is an element that is bonded to N in the manufacturing process of the grain-oriented electrical steel sheet to form AlN that functions as an inhibitor. However, when the sol. Al content in the base steel sheet exceeds 0.020%, the inhibitor excessively remains in the base steel sheet to deteriorate magnetic characteristics. Therefore, in the base steel sheet of the grain-oriented electrical steel sheet according to the embodiment, the sol. Al content is preferably 0.020% or less. The sol. Al content is more preferably 0.010% or less, and still more preferably less than 0.001%. The lower limit of the sol. Al content is not particularly limited, but even when the content is reduced to less than 0.0001%, manufacturing cost is merely increased. Therefore, the sol. Al content may be 0.0001% or more.

S: 0.010% or less

S (sulfur) is an element that is bonded to Mn in the manufacturing process to form MnS that functions as an inhibitor. However, when the S content exceeds 0.010%, the remaining inhibitor deteriorates magnetic characteristics. Therefore, in the base steel sheet of the grain-oriented electrical steel sheet according to the embodiment, the S content is preferably 0.010% or less. The S content in the grain-oriented electrical steel sheet is more preferably as low as possible. For example, the S content is less than 0.001%. However, even when the S content is reduced to less than 0.0001% in the grain-oriented electrical steel sheet, manufacturing cost is merely increased. Therefore, the S content may be 0.0001% or more in the grain-oriented electrical steel sheet.

### Balance: Fe and Impurities

The chemical composition of the base steel sheet of the grain-oriented electrical steel sheet according to the embodiment may contain the above-described elements, with the balance being Fe and impurities. However, the base steel sheet may further contain Sn, Cu, Se, and Sb in the following ranges for the purpose of improving magnetic characteristics and the like. In addition, for example, even when the base steel sheet contains any one or more of W, Nb, Ti, Ni, Co, V, Cr, and Mo in a total amount of 1.0% or less as elements other than these elements, the effect of the grain-oriented electrical steel sheet according to the embodiment is not impaired.

Here, the impurities are contaminated from ore or scrap as a raw material, or from a manufacturing environment or the like when the base steel sheet is industrially manufactured. The impurities mean elements allowed to be included in such a content that the action of the grain-oriented electrical steel sheet according to the embodiment is not adversely affected.

### Sn: 0 to 0.50%

Sn (tin) is an element that contributes to improvement in magnetic characteristics through primary crystallization structure control. In order to obtain an effect of improving magnetic characteristics, the Sn content is preferably 0.01% or more. The Sn content is more preferably 0.02% or more, and still more preferably 0.03% or more.

On the other hand, when the Sn content exceeds 0.50%, secondary recrystallization is unstable, and magnetic characteristics are deteriorated. Therefore, the Sn content is preferably 0.50% or less. The Sn content is more preferably 0.30% or less, and still more preferably 0.10% or less.

### Cu: 0 to 0.50%

Copper (Cu) is an element that contributes to an increase in Goss orientation occupancy in a secondary recrystallization structure. In order to obtain the above effect, the Cu content is preferably 0.01% or more. The Cu content is more preferably 0.02% or more, and still more preferably 0.03% or more.

On the other hand, when the Cu content exceeds 0.50%, the steel sheet is embrittled during hot rolling. Therefore, in the base steel sheet of the grain-oriented electrical steel sheet according to the embodiment, the Cu content is preferably 0.50% or less. The Cu content is more preferably 0.30% or less, and still more preferably 0.10% or less.

### Se: 0 to 0.020%

Se (selenium) is an element having an effect of improving magnetic characteristics. When Se is included, the Se content is preferably 0.001% or more such that Se favorably exhibits the effect of improving magnetic characteristics. The Se content is more preferably 0.003% or more, and still more preferably 0.006% or more.

On the other hand, when the Se content exceeds 0.020%, adhesion of the coating is deteriorated. Therefore, the Se content is preferably 0.020% or less. The Se content is more preferably 0.015% or less, and still more preferably 0.010% or less.

### Sb: 0 to 0.50%

Sb (antimony) is an element having an effect of improving magnetic characteristics. When Sb is included, the Sb content is preferably 0.005% or more such that Sb favorably exhibits the effect of improving magnetic characteristics. The Sb content is more preferably 0.01% or more, and still more preferably 0.02% or more.

On the other hand, when the Sb content exceeds 0.50%, adhesion of the coating is significantly deteriorated. Therefore, the Sb content is preferably 0.50% or less. The Sb content is more preferably 0.30% or less, and still more preferably 0.10% or less.

As described above, for example, the chemical composition of the base steel sheet of the grain-oriented electrical steel sheet according to the embodiment contains the above-described elements, with the balance being Fe and impurities.

The chemical composition of the base steel sheet of the grain-oriented electrical steel sheet according to the embodiment can be measured using a known ICP emission spectrometry. Note that, at the time of measurement, in a case where an insulating coating is formed on the surface, the measurement is performed after the insulating coating is peeled off. As a peeling method, it is possible to peel off the insulating coating by immersing the steel sheet in a high-concentration alkaline solution (for example, a 30% sodium hydroxide solution heated to 85° C.) for 20 minutes or more. It is possible to visually determine whether or not they have been peeled off. In a case of a small sample, the insulating coating may be peeled off by surface grinding.

### <Insulating Coating>

In the grain-oriented electrical steel sheet 100 according to the embodiment, the insulating coating 2 is formed on the surface of the base steel sheet 1.

The insulating coating 2 has a structure in which the intermediate layer 21 and the tension coating layer 22 are laminated in this order from the side of the base steel sheet 1.

### (Intermediate Layer)

As described above, in general, a grain-oriented electrical steel sheet has a forsterite-based coating generated in a finishing annealing step and an insulating coating (tension insulating coating) formed thereon. However, in recent years, it has been clarified that the forsterite-based coating hinders movement of a domain wall and adversely affects iron loss, and thus, in order to further improve magnetic characteristics, a grain-oriented electrical steel sheet having no forsterite-based coating has been studied. However, when the forsterite-based coating is not present, it is difficult to ensure sufficient adhesion between the tension insulating coating and the surface of the base steel sheet.

In the grain-oriented electrical steel sheet 100 according to the embodiment, the intermediate layer 21 containing a crystalline metal phosphate is formed between the base steel sheet 1 and the tension coating layer 2 to improve adhesion between the base steel sheet 1 and the tension coating layer 22 via the intermediate layer 21. This is because when the intermediate layer 21 contains a crystalline metal phosphate, the tension coating formed thereon (after formed, becomes the tension coating layer 22) also contains a crystalline metal phosphate and therefore has high affinity therewith, thereby exhibiting excellent adhesion between the intermediate layer and the tension coating layer. In addition, as described later, when the intermediate layer 1 is formed by immersion in a treatment liquid containing a metal phosphate, the intermediate layer 1 can be formed on the surface of the base steel sheet 1 using a chemical reaction, and adhesion between the intermediate layer 21 and the base steel sheet 1 can also be ensured.

When the intermediate layer 21 does not contain a crystalline metal phosphate, the above effect cannot be obtained. The percentage of the crystalline metal phosphate in the intermediate layer 21 is preferably 80 mass % or more, and may be 100 mass %. The metal phosphate is preferably any one of zinc phosphate, manganese phosphate, zinc calcium phosphate, and iron manganese phosphate from the viewpoint of adhesion.

The intermediate layer 21 may contain, as the balance of the metal phosphate, an oxide or an element diffused from the base steel sheet 1, such as Fe or Si.

Here, the present inventors studied the adhesion and magnetic characteristics of the intermediate layer 21 using a metal phosphate, and found that, when an intermediate layer mainly containing a metal phosphate is provided to try improving adhesion between the base metal and the insulating coating, the grain-oriented electrical steel sheet may have deteriorated magnetic characteristics. On this point, the present inventors further studied, and found that the magnetic characteristics deteriorate because, when the intermediate layer is formed, that is, when chemical conversion treatment is performed, the crystal of phosphate is precipitated, and at the same time, the surface of the base steel sheet is etched to form an uneven structure at the interface between the base steel sheet and the intermediate layer, so that magnetic flux flowing in the base steel sheet is suppressed.

The present inventor studied and found that the unevenness index also affects the space factor. The unevenness index increases since the chemical treatment solution etches the surface of the steel sheet when the intermediate layer is formed, and at the same time, the fine unevenness on the surface side of the intermediate layer 21 also increases. Therefore, the fine unevenness of the tension coating layer 22 formed above the intermediate layer 21 also increases, resulting in a reduced space factor.

Therefore, in the grain-oriented electrical steel sheet according to the embodiment, the degree of unevenness (unevenness degree) of the interface between the base steel sheet 1 and the intermediate layer 21 is reduced so that good adhesion and space factor are ensured, and deterioration of magnetic characteristics is suppressed. Specifically, in the grain-oriented electrical steel sheet according to the embodiment, when the interface between the base steel sheet 1 and the intermediate layer 21 is observed with a scanning electron microscope (SEM) at a magnification of 5000 in a cross section along the thickness direction of the intermediate layer 21, the ratio of the interface length L to the width W of analyzing image (unevenness index), L/W, is 100.0 to 120.0%.

FIG. 2 is a schematic view for illustrating how to determine the unevenness index L/W, and is a schematic cross-sectional view along the thickness direction of the intermediate layer 21.

First, as shown in FIG. 2, the cross section is observed at a magnification of 5000 with SEM to obtain an observation image including the interface between the base steel sheet 1 and the intermediate layer 21. Then, in the observation image, both ends of the interface between the base steel sheet 1 and the intermediate layer 21 are connected with a straight line, and the distance between the two points is defined as the width W of analyzing image; the actual interface path between both ends of the interface (that is, the curved path tracing the actual interface) is defined as the interface length L; and the unevenness index L/W (%) is determined. The unevenness index L/W is an index of the unevenness degree of the interface. When the unevenness index L/W is small, the unevenness degree is small and the interface is excellent in smoothness. Note that the degree of unevenness to be observed varies depending on SEM observation magnification. Therefore, the SEM observation magnification is in a range suitable for observing the interface, and is 5000 times in the embodiment.

In the cross section of the grain-oriented electrical steel sheet, the cross section from which an observation image for measuring the unevenness index L/W is obtained is selected from the flat portion where the surface of the grain-oriented electrical steel sheet has no surface flaw and is not surface-processed. The unevenness index L/W is calculated, using the average value of values measured from an observation image at three points.

The width W of analyzing image and the interface length L can be easily determined by using an application system “LUZEX AP” created by NIRECO CORPORATION or the like on a cross-sectional image obtained by an electron microscope.

In the embodiment, the unevenness index L/W is 100.0 to 120.0%. When the unevenness index L/W exceeds 120.0%, the unevenness degree at the interface increases, and magnetic characteristics may be deteriorated. Therefore, the unevenness index is 120.0% or less, preferably less than 120.0%, more preferably 118.0% or less, still more preferably 115.0% or less, and still more preferably 110.0% or less. The lower limit of the unevenness index L/W is 100.0%. When the unevenness index L/W is 100.0%, the width W of analyzing image and the interface length L matches each other, that is, the unevenness degree is zero, and the interface is smooth.

The thickness of the intermediate layer 21 is preferably 1.0 to 9.0 μm. When the average thickness of the intermediate layer 21 is less than 1.0 μm, the effect of improving the adhesion between the base steel sheet 1 and the insulating coating 2 via the intermediate layer 21 is sometimes not sufficiently obtained. On the other hand, when the average thickness of the intermediate layer 21 exceeds 9.0 μm, the magnetic characteristics may deteriorate.

The thickness of the intermediate layer 21 can be determined by the following method.

The thickness of the intermediate layer 21 can be determined by measurement using a scanning electron microscope (SEM) and an energy dispersive element analyzer. That is, a sample having a base steel sheet 1 and an insulating coating layer 2 is cut out, and the polished cross section is observed with a scanning electron microscope at a magnification of 5000, thereby measuring the thickness of the insulating coating layer 2. At this time, using an energy dispersive element analyzer, the insulating coating layer 2 can be calculated, such that the portion containing Si is the tension coating layer 22 and the portion containing no Si is the intermediate layer 21, to determine the thickness of the intermediate layer 21. Five or more positions are measured, and the average thereof is defined as the thickness of the intermediate layer 21.

Although the intermediate layer 21 and the tension coating layer 22 formed thereon are formed at different timings, both the intermediate layer 21 and the tension coating layer 22 exhibit the effect of the insulating coating 2.

As for the crystalline metal phosphate in the intermediate layer 21, the mass ratio of the metal phosphate and the type of the metal phosphate are determined by measuring the cross section of the intermediate layer 21 along the thickness direction with a scanning electron microscope (SEM) and an energy dispersive element analyzer. Whether the metal phosphate of the intermediate layer 21 is a crystalline metal phosphate can be determined by X-ray crystallography.

The base steel sheet 1 and the insulating coating 2 can be determined by whether phosphorus is contained. In the insulating coating 2, the intermediate layer 21 and the tension coating layer 22 can be determined by whether silicon is contained.

### (Tension Coating Layer)

The grain-oriented electrical steel sheet 100 according to the embodiment, in which a tension coating is formed on the surface of the intermediate layer 21, has the tension coating layer 22 on the surface side of the insulating coating 2.

The tension coating layer 22 is not particularly limited as long as it is used as an insulating coating of a grain-oriented electrical steel sheet, but preferably contains a metal phosphate from the viewpoint of adhesion to the intermediate layer 21 (adhesion to the base steel sheet 1 through the intermediate layer 21). In particular, it is preferable that the tension coating layer 22 mainly contains, as a composition, aluminum phosphate and silica.

The tension coating layer 22 preferably contains a metal phosphate and silica (derived from colloidal silica in the coating liquid) such that the silica content is 20.0 mass % or more. On the other hand, when the silica content in the tension coating layer 22 is more than 60.0 mass %, powderization occurs. Therefore, the silica content is preferably 60.0 mass % or less. The metal phosphate and silica are preferably contained in a total amount of 70.0 mass % or more. As the balance other than the metal phosphate and silica, ceramic fine particles such as alumina and silicon nitride may be included. The metal phosphate is preferably aluminum phosphate from the viewpoint of heat resistance.

The thickness of the tension coating layer 22 is not limited, but the average thickness as the insulating coating 2 (intermediate layer 21+tension coating layer 22) is preferably 2.0 to 20.0 μm when the average thickness of the intermediate layer 21 is in the above range. When the average thickness of the insulating coating 2 is less than 2.0 μm, a sufficient coating tension cannot be obtained. In addition, elution of phosphoric acid increases. In this case, this may cause stickiness and corrosion resistance deterioration, and may cause coating peeling. When the thickness of the insulating coating 2 is more than 20.0 μm, the space factor decreases to deteriorate magnetic characteristics, adhesion decreases due to cracking or the like, or corrosion resistance decreases.

In the tension coating layer 22, the mass percentage of the metal phosphate and the type of the metal phosphate can be determined in the cross section along the thickness direction in the same manner as in the intermediate layer 21.

As described above, the tension coating layer 22 and the intermediate layer 21 can be determined by the difference in the silica content.

The thickness of the tension coating layer 22 can be determined in the same manner as in the intermediate layer 21. The total of the thickness of the tension coating layer 22 and the thickness of the intermediate layer 21 is determined as the thickness of the insulating coating 2.

### <Manufacturing Method of Grain-Oriented Electrical Steel Sheet>

According to the manufacturing method satisfying the manufacturing conditions described below, the grain-oriented electrical steel sheet according to the embodiment can be suitably manufactured. Note that, as a matter of course, the grain-oriented electrical steel sheet according to the embodiment is not particularly limited in its manufacturing method. That is, a grain-oriented electrical steel sheet having the above-described configurations is regarded as the grain-oriented electrical steel sheet according to the embodiment, regardless of the manufacturing conditions thereof.

The grain-oriented electrical steel sheet according to the embodiment can be manufactured by a manufacturing method including the following steps:
(I) a hot rolling step of hot rolling a steel piece having a predetermined chemical composition to obtain a hot-band;
(II) a hot-band annealing step of annealing the hot-band;
(III) a cold rolling step of cold rolling the hot-band after the hot-band annealing step to obtain a steel sheet (cold-band);
(IV) a decarburization annealing step of decarburization annealing the steel sheet after the cold rolling step;
(V) a finishing annealing step of applying an annealing separator containing Al₂O₃ in an amount of 10 to 100 mass % onto a steel sheet, drying the steel sheet, and then final annealing the steel sheet;
(VII) an annealing separator removing step of removing an excess of the annealing separator from the steel sheet after the finishing annealing step;
(VIII) a pickling step of pickling the steel sheet after the annealing separator removing step with 0.1 to 5 mass % of one inorganic acid selected from the group consisting of sulfuric acid, chloric acid, nitric acid, and phosphoric acid for 1 to 20 seconds;
(IX) an immersing step of immersing the steel sheet after the pickling step in a treatment liquid containing a metal phosphate, nitric acid, and an iron ion, and having a liquid temperature of 20 to 85° C. for 5 to 150 seconds;
(X) a drying step of pulling up the steel sheet after the immersing step from the treatment liquid, removing an excess of the treatment liquid, and then drying the steel sheet; and
(XI) a tension coating layer forming step of applying a coating liquid containing a metal phosphate and colloidal silica, the metal phosphate and the colloidal silica contained in a total concentration of 10.0 to 40.0 mass % in terms of solid content, to the steel sheet after the drying step, drying the steel sheet, and then holding the steel sheet at a sheet temperature of 700 to 950° C. for 10 to 120 seconds.

In the manufacturing method of the grain-oriented electrical steel sheet according to the embodiment, the treatment liquid satisfies the following conditions in the immersing step:
(A) metal ion concentration: 1.0 to 10.0 g/L;
(B) phosphate ion concentration: 2.0 to 25.0 g/L;
(C) nitrate ion concentration: 2.0 to 40.0 g/L;
(D) iron ion concentration: 1.0 to 20.0 g/L;
(E) ratio of phosphate ion concentration to metal ion concentration: 1.5 to 5.0; and
(F) ratio of nitrate ion concentration to phosphate ion concentration: 0.5 to 10.0.

In addition, the manufacturing method of the grain-oriented electrical steel sheet according to the embodiment may further include one or both of
(XII) a nitriding treatment step of subjecting the steel sheet to a nitriding treatment between the decarburization annealing step and the finishing annealing step, and
(XIII) a magnetic domain refinement step of performing magnetic domain control of the steel sheet after the tension coating layer forming step.

Among these steps, (V) finishing annealing step to (XI) tension coating layer forming step (also collectively referred to as insulating coating forming step), which are mainly related to formation of the insulating coating, are characteristic in the manufacture of the grain-oriented electrical steel sheet according to the embodiment, and known conditions may be adopted for other steps or conditions not described.

Hereinafter, these steps will be described.

### [Hot Rolling Step]

In the hot rolling step, a steel piece having a predetermined chemical composition, such as a slab, is heated and then hot rolled to obtain a hot-band. The heating temperature of the steel piece is preferably in a range of 1100 to 1450° C. The heating temperature is more preferably 1300 to 1400° C.

The chemical composition of the steel piece is changed according to the chemical composition of the grain-oriented electrical steel sheet to be finally obtained, but, for example, the chemical composition includes, in terms of mass %, 0.01 to 0.20% of C, 2.50 to 4.00% of Si, 0.01 to 0.040% of sol. Al, 0.01 to 0.50% of Mn, 0.020% or less of N, 0.005 to 0.040% of S, 0 to 0.50% of Cu, 0 to 0.50% of Sn, 0 to 0.020% of Se, 0 to 0.50% of Sb, and a balance including Fe and impurities.

The hot rolling conditions are not particularly limited, and may be appropriately set based on required characteristics. The sheet thickness of the hot-band is preferably, for example, in a range of 2.0 mm or more and 3.0 mm or less.

### [Hot-Band Annealing Step]

The hot-band annealing step is a step of annealing the hot-band manufactured through the hot rolling step. By performing such an annealing treatment, recrystallization occurs in the metallographic structure, and favorable magnetic characteristics can be preferably achieved.

When hot-band annealing is performed, the hot-band manufactured through the hot rolling step is annealed according to a known method. The means for heating the hot-band at the time of annealing is not particularly limited, and a known heating method can be adopted. The annealing conditions are not particularly limited. For example, the hot-band can be annealed in a temperature range of 900 to 1200° C. for 10 seconds to 5 minutes.

### [Cold Rolling Step]

In the cold rolling step, the hot-band after the hot-band annealing step is subjected to cold rolling to obtain a steel sheet (cold-band). The cold rolling may be performed one time (continuously performed without intervening intermediate annealing(s)). Alternatively, before the final pass in the cold rolling step, intermediate annealing may be performed at least one time or two or more times by interrupting cold rolling, that is, cold rolling may be performed several times with intervening intermediate annealing(s).

When the intermediate annealing is performed, it is preferable to hold the hot-band at a temperature of 1000 to 1200° C. for 5 to 180 seconds. The annealing atmosphere is not particularly limited. The number of times of intermediate annealing is preferably 3 or less in consideration of manufacturing cost.

In addition, before the cold rolling step, the surface of the hot-band may be subjected to pickling.

In the cold rolling step according to the embodiment, the hot-band after the hot-band annealing step is cold rolled according to a known method to form a steel sheet. For example, the final rolling reduction can be in a range of 80 to 95%. When the final rolling reduction is 80% or more, a Goss nucleus in which the {110}<001> orientation has a high development degree in a rolling direction can be obtained, which is preferable. On the other hand, when the final rolling reduction exceeds 95%, there is a high possibility that secondary recrystallization is unstable in the subsequent finishing annealing step, which is not preferable.

The final rolling reduction is a cumulative rolling reduction of cold rolling, and when intermediate annealing is performed, the final rolling reduction is a cumulative rolling reduction of cold rolling after the final intermediate annealing.

### [Decarburization Annealing Step]

In the decarburization annealing step, the obtained steel sheet is subjected to decarburization annealing. In the decarburization annealing, decarburization annealing conditions are not limited as long as the steel sheet can be primarily recrystallized and C, which adversely affects the magnetic characteristics, can be removed from the steel sheet. For example, the steel sheet is held at an annealing temperature of 800 to 900° C. for 10 to 600 seconds with a degree of oxidation (PH₂O/PH₂) of 0.3 to 0.6 in an annealing atmosphere (furnace atmosphere).

### [Nitriding Treatment Step]

A nitriding treatment may be performed between the decarburization annealing step and the finishing annealing step described later.

In the nitriding treatment step, for example, the steel sheet after the decarburization annealing step is maintained at about 700 to 850° C. in a nitriding treatment atmosphere (atmosphere containing a gas having nitriding ability, such as hydrogen, nitrogen, or ammonia) to perform the nitriding treatment. When AlN is utilized as an inhibitor, the N content of the steel sheet after the nitriding treatment step is preferably 40 ppm or more by the nitriding treatment. On the other hand, when the N content of the steel sheet after the nitriding treatment step exceeds 1000 ppm, AlN is excessively present in the steel sheet even after completion of secondary recrystallization in the finishing annealing. Such AlN causes iron loss deterioration. Therefore, the N content of the steel sheet after the nitriding treatment step is preferably 1000 ppm or less.

### [Finishing Annealing Step]

In the finishing annealing step, an annealing separator containing 10 to 100 mass % of Al₂O₃ is applied to the steel sheet that is after the decarburization annealing step or has been further subjected to the nitriding treatment (after the nitriding treatment step), and dried, and then finishing annealing is performed.

In a conventional manufacturing method of a grain-oriented electrical steel sheet, a forsterite-based coating is formed on the surface of a steel sheet (cold-band) by applying an annealing separator mainly containing MgO and performing finishing annealing.

On the other hand, in the manufacturing method of the grain-oriented electrical steel sheet according to the embodiment, an annealing separator containing Al₂O₃ is used to form substantially no forsterite-based coating.

On the other hand, the percentage of Al₂O₃ may be 100 mass %. However, in the manufacturing method of the grain-oriented electrical steel sheet according to the embodiment, the annealing separator preferably contains MgO from the viewpoint of preventing the sheet surface from being baked with Al₂O₃. MgO may be 0%, but the percentage of MgO is preferably 5 mass % or more to obtain the above effect. When MgO is contained, the percentage of MgO is 90 mass % or less in order to ensure 10 mass % or more of Al₂O₃. The percentage of MgO is preferably 50 mass % or less.

In addition, in the manufacturing method of the grain-oriented electrical steel sheet according to the embodiment, the annealing separator may further contain a chloride. When the annealing separator contains a chloride, an effect that a forsterite-based coating is more hardly formed can be obtained. The amount of the chloride is not particularly limited, and may be 0%, but is preferably 0.5 to 10 mass % when the above effect is to be obtained. As the chloride, for example, bismuth chloride, calcium chloride, cobalt chloride, iron chloride, and nickel chloride are effective.

Finishing annealing conditions are not limited, but for example, a condition of holding the steel sheet at a temperature of 1150 to 1250° C. for 10 to 60 hours can be adopted.

### [Annealing Separator Removing Step]

In the annealing separator removing step, an excess of the annealing separator is removed from the steel sheet after the finishing annealing step. For example, the excess of the annealing separator can be removed by performing water washing.

### [Pickling Step]

In the pickling step, the steel sheet after the annealing separator removing step is subjected to pickling with 0.1 to 10 mass % of one inorganic acid selected from the group consisting of sulfuric acid, phosphoric acid, nitric acid, and chloric acid for 1 to 20 seconds, the inorganic acid heated to 30 to 85° C. Pickling under these conditions can exhibit an effect that the forsterite-based coating can be sufficiently removed, and MgO, if remaining, can be removed. However, so-called pickling pits are hardly formed in the pickling step of the embodiment.

### [Immersing Step]

### [Drying Step]

In the immersing step, the steel sheet after the pickling step is immersed in a treatment liquid containing a metal phosphate and nitric acid for 5 to 150 seconds. In the drying step, the steel sheet after the immersing step is pulled up from the treatment liquid, an excess of the treatment liquid is removed, and then the steel sheet is dried. Thereby, the intermediate layer is formed on the surface of the base steel sheet.

In the immersing step, the treatment liquid is adjusted to satisfy the following conditions (A) to (F).
(A) Metal ion concentration: 1.0 to 10.0 g/L
(B) Phosphate ion concentration: 2.0 to 25.0 g/L

The treatment liquid contains a metal phosphate and nitric acid as an oxidizing agent. Examples of the metal phosphate include zinc phosphate, manganese phosphate, calcium zinc phosphate, and manganese iron phosphate. From the viewpoint of control of the unevenness index, zinc phosphate is preferable.

In the treatment liquid, the metal ion concentration and the phosphate ion concentration are 1.0 to 10.0 g/L and 2.0 to 25.0 g/L, respectively. When the metal ion concentration is less than 1.0 g/L, the precipitation rate of phosphate is relatively slow and the surface of the steel sheet is etched, so that there is a possibility that the unevenness degree of the interface increases, the unevenness index L/W increases, and the magnetic characteristics deteriorate. Similarly, when the phosphate ion concentration is less than 2.0 g/L, there is a possibility that the unevenness degree of the interface increases, the unevenness index L/W increases, and the magnetic characteristics deteriorate. Therefore, the metal ion concentration and the phosphate ion concentration are preferably 1.0 g/L or more and 2.0 g/L or more, respectively.

On the other hand, when the metal ion concentration is more than 10.0 g/L, the pH of the treatment liquid increases and the precipitation rate of the metal phosphate also decreases, so that there is a possibility that the unevenness degree of the interface increases, the unevenness index L/W increases, and the magnetic characteristics deteriorate. Similarly, when the phosphate ion concentration is more than 25.0 g/L, there is a possibility that the unevenness degree of the interface increases, the unevenness index L/W increases, and the magnetic characteristics deteriorate. Therefore, the metal ion concentration and the phosphate ion concentration are preferably 10.0 g/L or less and 25.0 g/L or less, respectively.
(C) Nitrate ion concentration: 2.0 to 40.0 g/L

As described above, nitric acid is added as an oxidizing agent to the treatment liquid according to the embodiment. Nitric acid, used as an oxidizing agent, makes it possible to prevent hydrogen gas generation and to efficiently form a dense intermediate layer. However, when nitric acid is added in the treatment liquid in an excessively large amount, the surface of the steel sheet is excessively oxidized and the precipitation rate of the phosphate is reduced, so that there is a possibility that the unevenness degree of the interface increases, the unevenness index L/W increases, and the magnetic characteristics deteriorate. Therefore, the nitrate ion concentration is preferably 40.0 g/L or less, and more preferably 25.0 g/L or less. On the other hand, when nitric acid is added in the treatment liquid in an excessively small amount, hydrogen gas generation cannot be suppressed and a region where phosphate is precipitated in an excessively small amount is formed in some parts, so that there is a possibility that the unevenness degree of the interface increases, the unevenness index L/W increases, and the magnetic characteristics deteriorate. Therefore, the acid ion concentration is preferably 2.0 g/L or more.
(D) Iron ion concentration: 1.0 to 20.0 g/L

It is presumed that, iron ions, contained in the treatment liquid in an appropriate amount, have an action of suppressing the etching action of the metal phosphate treatment liquid and reducing the dissolution rate of the surface of the steel sheet. In order to obtain such an action, the iron ion concentration is preferably 1.0 g/L or more. On the other hand, when iron ions are contained in the treatment liquid in an excessively large amount, iron is precipitated in the generated intermediate layer to reduce adhesion. Therefore, the iron ion concentration is preferably 20.0 g/L or less.
(E) Ratio of phosphate ion concentration to metal ion concentration: 1.5 to 5.0

From the viewpoint of optimizing the unevenness index, it is effective that the phosphoric acid concentration and the metal ion concentration are within the above range, as described above. However, the ratio of the phosphate ion concentration to the metal ion concentration is preferably adjusted. Specifically, the ratio between the phosphate ion concentration and the metal ion concentration (phosphate ion concentration/metal ion concentration) is 1.5 to 5.0. When the ratio between the phosphate ion concentration and the metal ion concentration is excessively large, there is a possibility that etching proceeds to make the steel sheet excessively uneven, resulting in an inferior space factor. Therefore, the ratio of the phosphate ion concentration to the metal ion concentration is preferably 5.0 or less. On the other hand, when the ratio of the phosphate ion concentration to the metal ion concentration is excessively small, there is a possibility that the pH increases, and thereby the metal phosphate does not precipitate, or takes a lot of time to precipitate. Therefore, the ratio of the phosphate ion concentration to the metal ion concentration is preferably 1.5 or more.
(F) Ratio of nitrate ion concentration to phosphate ion concentration: 0.5 to 10.0

From the viewpoint of the precipitation rate, the ratio of the nitrate ion concentration to the phosphate ion concentration is also adjusted. Specifically, the ratio of the nitrate ion concentration to the phosphate ion concentration (nitrate ion concentration/phosphate ion concentration) is 0.5 to 10.0. When the ratio of the nitrate ion concentration to the phosphate ion concentration is excessively large, the steel sheet may be excessively etched. Therefore, the ratio of the nitrate ion concentration to the phosphate ion concentration is preferably 10.0 or less. On the other hand, when the ratio of the nitrate ion concentration to the phosphate ion concentration is excessively small, there is a possibility that precipitation of the metal phosphate is suppressed, and it takes time to form the intermediate layer. Therefore, the ratio between the nitric acid concentration and the phosphate ion concentration is preferably 0.5 or more.

It is preferable that the liquid temperature of the treatment liquid is 20 to 85° C., and the immersion time is 5 to 150 seconds. When the liquid temperature is lower than 20° C. or the immersion time is less than 5 seconds, there is a possibility that the intermediate layer is insufficiently formed and becomes inferior in adhesion. On the other hand, when the liquid temperature is higher than 85° C. or the process time is longer than 150 seconds, there is a possibility that the intermediate layer has a region where the crystalline metal phosphate is partially excessively precipitated and becomes inferior in space factor.

In the drying step, when the drying temperature is high, there is a possibility that voids generate, leading to poor adhesion. Therefore, the drying temperature is preferably 300° C. or lower, and more preferably 200° C. or lower. The drying temperature is preferably 100° C. or higher.

### [Tension Coating Layer Forming Step]

In the tension coating layer forming step, a coating liquid containing a metal phosphate and colloidal silica in a concentration of 10 to 40 mass % is applied to the steel sheet after the drying step, the steel sheet is dried, and then the steel sheet is heated and held at a sheet temperature of 700 to 950° C. for 10 to 50 seconds, thereby forming a tension coating layer on the surface of the intermediate layer.

When the sheet temperature is held at lower than 700° C., the tension is low and magnetic characteristics are poor. Therefore, the sheet temperature is preferably 700° C. or higher. On the other hand, when the sheet temperature is higher than 950° C., the rigidity of the steel sheet decreases and the steel sheet is easily deformed. In this case, the steel sheet may be distorted due to transfer or the like, resulting in poor magnetic characteristics. Therefore, the sheet temperature is preferably 950° C. or lower.

When the holding time is less than 10 seconds, elution is poor. Therefore, the holding time is 10 seconds or more. On the other hand, when the holding time is more than 50 seconds, the adhesion of the tension coating layer may be poor. Therefore, the holding time is preferably 50 seconds or less.

The coating liquid (insulating coating solution) is adjusted so that the metal phosphate and the colloidal silica are contained in a total amount of 10 to 40 mass % in terms of solid content.

When the total concentration of the metal phosphate and the colloidal silica is less than 10 mass %, the applied treatment liquid easily flows, which may cause uneven application amount. In addition, when the total concentration of the metal phosphate and the colloidal silica is more than 40 mass %, the viscosity becomes too high, which may cause a pattern or coating unevenness.

As the metal phosphate, for example, one or a mixture of two or more selected from aluminum phosphate, zinc phosphate, magnesium phosphate, nickel phosphate, copper phosphate, lithium phosphate, and cobalt phosphate can be used. Among them, aluminum phosphate is preferable.

The coating liquid may contain vanadium, tungsten, molybdenum, zirconium, and the like as additional elements. When these elements are contained, they can be added to the coating liquid, for example, as an oxygen acid.

As the colloidal silica, S-type or C-type can be used. The S-type colloidal silica is alkaline in silica solution. The C-type has its silica particle surface treated with aluminum, and is alkaline to neutral in silica solution. The S-type colloidal silica is widely and generally used, and is relatively inexpensive in price, but it is necessary to be careful because the S-type colloidal silica may aggregate and precipitate when being mixed with an acidic metal phosphate solution. The C-type colloidal silica is stable even when being mixed with a metal phosphate solution, and there is no possibility of precipitation, but the C-type colloidal silica is relatively expensive because the number of treatment steps is large. It is preferable to select and use them according to the stability of a coating liquid to be prepared.

### [Magnetic Domain Refinement Step]

The manufacturing method of the grain-oriented electrical steel sheet according to the embodiment may further include a magnetic domain refinement step of performing magnetic domain refinement on the steel sheet after the tension coating layer forming step.

By performing the magnetic domain refinement treatment, the iron loss of the grain-oriented electrical steel sheet can be further reduced.

The method of the magnetic domain refinement treatment include: a method for narrowing the width of a 180° magnetic domain (performing refinement of a 180° magnetic domain) by forming linear or dotted groove parts extending in a direction intersecting a rolling direction at predetermined intervals in the rolling direction; and a method for narrowing the width of a 180° magnetic domain (performing refinement of a 180° magnetic domain) by forming linear or dotted stress-strain parts or groove parts extending in a direction intersecting a rolling direction at predetermined intervals in the rolling direction.

In a case where a stress-strain part is formed, laser beam irradiation, electron beam irradiation, and the like can be applied. In a case where a groove part is formed, a mechanical groove forming method using a gear or the like, a chemical groove forming method of forming a groove by electrolytic etching, a thermal groove forming method by laser irradiation, and the like can be applied.

In a case where the insulating coating is damaged due to formation of a stress-strain part or a groove part and characteristics such as insulation properties are deteriorated, the insulating coating may be formed again to repair the damage.

### EXAMPLES

A slab including, in terms of mass %, 0.08% of C, 3.31% of Si, 0.028% of sol. Al, 0.008% of N, 0.07% of Mn, less than 0.0005% of S, and a balance including Fe and impurities was cast.

This slab was heated to 1350° C. and then hot rolled to form a hot-band having a sheet thickness of 2.2 mm.

The hot-band was annealed (hot-band annealed) under the conditions of holding at 1100° C. for 10 seconds.

Thereafter, the hot-band was cold rolled to obtain a cold-band having a sheet thickness of 0.22 mm.

The cold-band was decarburization annealed under the conditions of holding at 830° C. for 90 seconds.

After decarburization annealing, an annealing separator containing 95% of MgO and Al₂O₃ and 5% of BiCl₃ as a bismuth chloride was applied and dried, and then finishing annealing is performed at 1200° C. for 20 hours.

After finishing annealing, the steel sheet was washed with water to remove an excess of the annealing separator. As a result, a forsterite-based coating was not formed on the surface of the steel sheet.

The steel sheet was subjected to light pickling with 3 mass % sulfuric acid at 80° C. for 10 seconds.

After light pickling, an intermediate layer was formed using the treatment liquid shown in Table 1. As the supply source of iron ions, steel wool was used, and a treatment liquid was prepared so as to have a concentration as shown in Table 1. The immersion conditions were as shown in Table 1. The obtained intermediate layer was as shown in Table 1.

Thereafter, an insulating coating treatment liquid mainly containing a metal phosphate and colloidal silica shown in Table 2 was applied, and dried at 850° C. for 20 seconds after the application, to form a tension coating layer on the surface of the steel sheet.

In Table 2, the “Metal element molar ratio” indicates the abundance ratio of metal elements when two or more metal elements are present in the metal phosphate.

The thickness of the insulating coating (intermediate layer and tension coating layer) was as shown in Table 2. The tension coating layer was substantially made of a metal phosphate and silica.

The obtained steel sheet (grain-oriented electrical steel sheet) was irradiated with a laser beam under the conditions that UA (irradiation energy density) was 2.0 J and the irradiation interval was 5.0 mm pitch, thereby performing magnetic domain refinement.

After magnetic domain refinement, the iron loss W17/50 of the steel sheet (iron loss at 50 Hz under 1.7 T) was measured by the Single Sheet Tester: SST in accordance with JIS C2556 (2015). When the iron loss W17/50 was 0.68 W/kg or less, it was determined that good magnetic characteristics were secured.

In addition, the space factor was measured in the following manner.

### [Space Factor]

The space factor was measured by a method in accordance with JIS C 2550-5 (2020). The test piece had a width of 30 mm and a length of 320 mm, and 30 pieces were used. The samples were measured for the total mass, and then pressurized at 1 MPa, where the space between the upper and lower cover plates sandwiching the laminate was measured to calculate space factor.

When the space factor was 96.0% or more, it was determined that a high space factor was secured.

In addition, the coating adhesion, coating tension, corrosion resistance, and elution resistance of the steel sheet after magnetic domain refinement were evaluated by the following methods. The unevenness index of the interface was determined by the following method. The results are shown in Tables 2 and 3.

### [Unevenness Index of Interface]

First, using a scanning electron microscope, a region including the interface between the base steel sheet and the intermediate layer was observed at a magnification of 5000 to obtain an observation image. Then, in the observation image, both ends of the interface between the base steel sheet and the intermediate layer were connected with a straight line, and the distance between the two points was defined as the width W of analyzing image, and the width W of analyzing image was determined. Further, the actual interface path (that is, the curved path tracing the actual interface) was defined as the interface length L, and the interface length L was determined, and the unevenness index L/W was determined. The width W of analyzing image and the interface length L were determined by using an application system “LUZEX AP” created by NIRECO CORPORATION or the like on a cross-sectional image obtained by an electron microscope.

### [Coating Adhesion]

For coating adhesion, a sample having a width of 30 mm and a length of 300 mm was collected from the steel sheet, and the sample was subjected to stress relief annealing at 800° C. for 2 hours in a nitrogen stream. Thereafter, the sample was subjected to a bending and adhering test in which the sample was wound and unwound around a 10 mmφ cylinder, and then the coating was evaluated for peeling degree (area fraction).

Evaluation criteria were as follows, and when a sample was evaluated as ⊙ or ∘, the sample was determined to have excellent coating adhesion.
⊙: Peeling area fraction: 0 to 0.5%
∘: Peeling area fraction: more than 0.5% and 5.0% or less
Δ: Peeling area fraction: more than 5.0%

### [Coating Tension]

The coating tension was calculated by back calculation from the curved state when one surface of the insulating coating was peeled off. When the obtained coating tension was 4.0 MPa or more, it was determined that the coating tension was sufficient.

### [Corrosion Resistance]

For corrosion resistance, a 5% NaCl aqueous solution was naturally dropped to the sample for 7 hours in an atmosphere of 35° C. in accordance with JIS: Methods of salt spray testing (JIS Z2371: 2015).

Thereafter, a rusting area was evaluated at 10 points. Here, the evaluation criteria are as follows. For corrosion resistance, when the score was 5 or more, it was determined that corrosion resistance was excellent.
10: No rust was generated.
9: Rust was generated in an extremely small amount (area fraction was 0.10% or less).
8: Rust was generated in an area fraction of more than 0.10% and 0.25% or less.
7: Rust was generated in an area fraction of more than 0.25% and 0.50% or less.
6: Rust was generated in an area fraction of more than 0.50% and 1.0% or less.
5: Rust was generated in an area fraction of more than 1.0% and 2.5% or less.
4: Rust was generated in an area fraction of more than 2.5% and 5.0% or less.
3: Rust was generated in an area fraction of more than 5.0% and 10% or less.
2: Rust was generated in an area fraction of more than 10% and 25% or less.
1: Rust was generated in an area fraction of more than 25% and 50% or less.

### [Elution Resistance]

The elution resistance was evaluated by whether the elution of phosphoric acid from the sample could be suppressed.

The method for measuring the elution amount was as follows: the sample was boiled in boiled pure water for 10 minutes, the amount of phosphoric acid eluted in the pure water was measured, and the amount of phosphoric acid was divided by the area of the insulating coating of the boiled grain-oriented electrical steel sheet. The amount of phosphoric acid eluted in pure water was measured and calculated as follows: the pure water to which phosphoric acid was eluted (solution) was cooled, and the cooled solution was diluted with pure water to prepare a sample, and the sample was measured for the phosphoric acid concentration with ICP-AES.

When the elution amount was less than 40 mg/m², it was determined that the elution resistance was excellent.

| | | | | | | Ratio between | Ratio between | | | | |
|---|---|---|---|---|---|---|---|---|---|---|---|
| | | | | | | metal ion con- | phosphoric | | | Intermediate | |
| | | | | | | centration and | acid | Treatment conditions | | layer | |
| | | lon concentration (g/L) | | | | phosphoric | concentration | Temperature × | | Unevenness | |
| | Metal | Metal | Phosphate | Nitrate | Iron | acid | and nitric acid | Time (° C.) | Thickness | index of | |
| NO. | phosphate | ion | ion | ion | ion | concentration | concentration | (sec) | (μm) | interface | Note |
| 1 | Zinc phosphate | 1.4 | 3.5 | 10.0 | 3.0 | 2.5 | 2.9 | 40° C × 80 sec | 1.6 | 111.6 | Invention |
| | | | | | | | | | | | Example |
| 2 | Zinc phosphate | 2.2 | 7.0 | 10.0 | 5.0 | 3.2 | 1.4 | 30° C × 50 sec | 2.1 | 106.4 | Invention |
| | | | | | | | | | | | Example |
| 3 | Manganese | 3.3 | 10.0 | 7.5 | 1.0 | 3.0 | 0.8 | 85° C × 8 sec | 4.5 | 101.7 | Invention |
| | phosphate | | | | | | | | | | Example |
| 4 | Manganese | 5.0 | 18.0 | 12.5 | 10.0 | 3.6 | 0.7 | 85° C × 10 sec | 3.5 | 109.3 | Invention |
| | phosphate | | | | | | | | | | Example |
| 5 | Zinc calcium | 3.5 | 11.0 | 16.5 | 7.0 | 3.1 | 1.5 | 80° C × 12 sec | 2.6 | 103.1 | Invention |
| | phosphate | | | | | | | | | | Example |
| 6 | Zinc phosphate | 2.4 | 6.0 | 36.0 | 13.0 | 2.5 | 6.0 | 40° C × 60 sec | 1.4 | 108.4 | Invention |
| | | | | | | | | | | | Example |
| 7 | Manganese | 4.5 | 20.0 | 12.0 | 7.0 | 4.4 | 0.6 | 85° C × 8 sec | 6.5 | 115.2 | Invention |
| | phosphate | | | | | | | | | | Example |
| 8 | Zinc phosphate | 2.0 | 4.0 | 32.0 | 12.0 | 2.0 | 8.0 | 50° C × 30 sec | 2.6 | 103.6 | Invention |
| | | | | | | | | | | | Example |
| 9 | Manganese | 2.2 | 4.0 | 44.0 | 7.0 | 1.8 | 11.0 | 80° C × 40 sec | 0.6 | 124.5 | Comparative |
| | phosphate | | | | | | | | | | Example |
| 10 | Manganese | 3.5 | 10.0 | 3.0 | 1.0 | 2.9 | 0.3 | 60° C × 90 sec | 10.4 | 120.5 | Comparative |
| | phosphate | | | | | | | | | | Example |
| 11 | Zinc phosphate | 4.5 | 26.0 | 15.0 | 6.0 | 5.8 | 0.6 | 40° C × 90 sec | 11.6 | 127.8 | Comparative |
| | | | | | | | | | | | Example |
| 12 | Zinc phosphate | 1.5 | 1.0 | 3.0 | 0.7 | 0.7 | 3.0 | 60° C × 120 sec | 5.1 | 131.4 | Comparative |
| | | | | | | | | | | | Example |
| 13 | Zinc phosphate | 15.5 | 22.0 | 15.0 | 2.0 | 1.4 | 0.7 | 75° C × 50 sec | 10.8 | 137.3 | Comparative |
| | | | | | | | | | | | Example |
| 14 | Zinc phosphate | 0.6 | 3.5 | 10.0 | 5.0 | 5.8 | 2.9 | 75° C × 120 sec | 1.6 | 130.8 | Comparative |
| | | | | | | | | | | | Example |

| | | | | | | Tension | | |
|---|---|---|---|---|---|---|---|---|
| | | Insulating coating treatment liquid | | | | coating | | |
| | Intermediate | | Metal | | | layer | | |
| | layer | | element | | Parts | Silica | Insulating | |
| | treatment | Phosphate | molar | Colloidal | by | content | layer | |
| No. | No. | (100 parts by weight) | ratio | silica | weight | (mass %) | (μm) | Note |
| 1 | 1 | Aluminum phosphate | — | C-type | 125 | 38.5 | 5.3 | Invention Example |
| 2 | 2 | Zinc phosphate | — | S-type | 90 | 40.3 | 5.6 | Invention Example |
| 3 | 3 | Aluminum/Zirconium | 0.18 | S-type | 80 | 37.5 | 9.3 | Invention Example |
| | | phosphate | | | | | | |
| 4 | 4 | Aluminum/Copper | 0.14 | S-type | 55 | 29.2 | 8.1 | Invention Example |
| | | phosphate | | | | | | |
| 5 | 5 | Aluminum/Lithium | 0.14 | S-type | 80 | 37.5 | 6.7 | Invention Example |
| | | phosphate | | | | | | |
| 6 | 6 | Aluminum/Barium | 0.17 | S-type | 80 | 37.5 | 6.1 | Invention Example |
| | | phosphate | | | | | | |
| 7 | 7 | Aluminum/Molybdenum | 0.17 | S-type | 135 | 50.3 | 7.6 | Invention Example |
| | | phosphate | | | | | | |
| 8 | 8 | Aluminum/Vanadium | 0.18 | S-type | 60 | 31.0 | 5.3 | Invention Example |
| | | phosphate | | | | | | |
| 9 | 1 | Aluminum/Tungsten | 0.17 | S-type | 100 | 42.9 | 7.3 | Invention Example |
| | | phosphate | | | | | | |
| 10 | 3 | Aluminum/Zirconium | 0.18 | S-type | 85 | 38.9 | 5.1 | Invention Example |
| | | phosphate | | | | | | |
| 11 | 9 | Aluminum phosphate | — | C-type | 80 | 28.6 | 10.4 | Comparative |
| | | | | | | | | Example |
| 12 | 10 | Aluminum phosphate | — | C-type | 80 | 28.6 | 11.8 | Comparative |
| | | | | | | | | Example |
| 13 | 11 | Aluminum phosphate | — | C-type | 80 | 28.6 | 13.5 | Comparative |
| | | | | | | | | Example |
| 14 | 12 | Aluminum phosphate | — | C-type | 100 | 33.3 | 10.2 | Comparative |
| | | | | | | | | Example |
| 15 | 13 | Aluminum phosphate | — | C-type | 120 | 37.5 | 11.4 | Comparative |
| | | | | | | | | Example |
| 16 | 14 | Aluminum phosphate | — | C-type | 120 | 37.5 | 12.5 | Comparative |
| | | | | | | | | Example |

TABLE 3

| | | Coating | | Elution | Space | | |
|---|---|---|---|---|---|---|---|
| | Coating | tension | Corrosion | resistance | factor | Iron loss | |
| No. | adhesion | (MPa) | resistance | (mg/m²) | (%) | (W17/50) (W/kg) | Note |
| 1 | ◯ | 8.1 | 9 | 27 | 97.1 | 0.65 | Invention Example |
| 2 | ◯ | 7.3 | 8 | 2 | 97.3 | 0.63 | Invention Example |
| 3 | ⊙ | 9.8 | 8 | 14 | 96.8 | 0.59 | Invention Example |
| 4 | ⊙ | 10.2 | 8 | 8 | 97.1 | 0.62 | Invention Example |
| 5 | ◯ | 7.5 | 8 | 18 | 97.3 | 0.64 | Invention Example |
| 6 | ◯ | 6.9 | 7 | 28 | 97.6 | 0.65 | Invention Example |
| 7 | ⊙ | 10.6 | 9 | 10 | 97 | 0.62 | Invention Example |
| 8 | ◯ | 8.4 | 7 | 29 | 97.7 | 0.61 | Invention Example |
| 9 | ◯ | 5.9 | 7 | 23 | 97.3 | 0.67 | Invention Example |
| 10 | ◯ | 9.4 | 8 | 16 | 97.8 | 0.62 | Invention Example |
| 11 | ◯ | 9.4 | 6 | 25 | 95.9 | 0.65 | Comparative |
| | | | | | | | Example |
| 12 | ◯ | 7.1 | 7 | 31 | 95.1 | 0.68 | Comparative |
| | | | | | | | Example |
| 13 | Δ | 4.7 | 7 | 12 | 94.4 | 0.73 | Comparative |
| | | | | | | | Example |
| 14 | ◯ | 9.3 | 4 | 44 | 95.4 | 0.69 | Comparative |
| | | | | | | | Example |
| 15 | Δ | 3.6 | 4 | 51 | 95.6 | 0.79 | Comparative |
| | | | | | | | Example |
| 16 | ◯ | 8.8 | 6 | 34 | 94.7 | 0.67 | Comparative |
| | | | | | | | Example |

As can be seen from Tables 1 to 3, the Invention Examples are extremely excellent in each property such as coating adhesion, and are improved in iron loss and space factor.

On the other hand, Comparative Examples are inferior at least one of coating adhesion, magnetic properties, corrosion resistance, elution resistance, and the space factor of a transformer (core).

### REFERENCE SIGNS LIST

100 Grain-oriented electrical steel sheet
1 Base steel sheet
2 Insulating coating
21 Intermediate layer
22 Tension coating layer

### INDUSTRIAL APPLICABILITY

According to the embodiment of the present invention, it is possible to provide a grain-oriented electrical steel sheet that is excellent in adhesion with a tension coating and magnetic characteristics, and does not reduce the space factor of a transformer (core). Therefore, the obtained grain-oriented electrical steel sheet can be suitably applied to an iron core material of a transformer, and thus has high industrial applicability.

1. A grain-oriented electrical steel sheet comprising: a base steel sheet; and an insulating coating formed on a surface of the base steel sheet, wherein
the insulating coating includes:
an intermediate layer that is formed on a side of the base steel sheet and contains a crystalline metal phosphate; and
a tension coating layer formed on a surface side of the insulating coating, and
when an interface between the base steel sheet and the intermediate layer is observed with a scanning electron microscope at a magnification of 5000 in a cross section along a thickness direction of the intermediate layer, a ratio of an interface length L to a width W of analyzing image is 100.0 to 120.0%.

2. The grain-oriented electrical steel sheet according to claim 1, wherein the tension coating layer contains a metal phosphate and silica.

3. A method for forming the insulating coating included in the grain-oriented electrical steel sheet according to claim 1, the method comprising:
a finishing annealing step of applying an annealing separator containing Al₂O₃ in an amount of 10 to 100 mass % onto a steel sheet, drying the steel sheet, and then final annealing the steel sheet;
an annealing separator removing step of removing an excess of the annealing separator from the steel sheet after the finishing annealing step;
a pickling step of pickling the steel sheet after the annealing separator removing step with 0.1 to 5 mass % of an inorganic acid selected from sulfuric acid, chloric acid, nitric acid, and phosphoric acid for 1 to 20 seconds;
an immersing step of immersing the steel sheet after the pickling step in a treatment liquid containing a metal phosphate, an oxidizing agent, and an iron ion;
a drying step of pulling up the steel sheet after the immersing step from the treatment liquid, removing an excess of the treatment liquid, and then drying the steel sheet; and
a tension coating layer forming step of applying a coating liquid containing a metal phosphate and colloidal silica, the metal phosphate and the colloidal silica contained in a total concentration of 10 to 40 mass % in terms of solid content, to the steel sheet after the drying step, drying the steel sheet, and then holding the steel sheet at a sheet temperature of 700 to 950° C. for 10 to 120 seconds, wherein
the treatment liquid has:
a metal ion concentration of 1.0 to 10.0 g/L;
a phosphate ion concentration of 2.0 to 25.0 g/L;
a nitrate ion concentration of 2.0 to 40.0 g/L; and
an iron ion concentration of 1.0 to 20.0 g/L, wherein
the phosphate ion concentration is in a ratio of 1.5 to 5.0 with respect to the metal ion concentration, and
the nitrate ion concentration is in a ratio of 0.5 to 10.0 with respect to the phosphate ion concentration.

4. The method for forming an insulating coating according to claim 3, wherein, in the immersing step, the steel sheet after the pickling step is immersed in the treatment liquid having a liquid temperature of 20 to 85° C. for 2 to 60 seconds.

5. The method for forming an insulating coating according to claim 3, wherein the nitrate ion concentration is 2.0 to 25.0 g/L.
